(19) United States
(12) Patent Application Publication
(10) Pub. No.: US 2026/0269218 A1
(43) Pub. Date: Sep. 10, 2026

(54) HIERARCHICAL NETWORK CATHODE MATERIALS FOR LITHIUM-SULFUR BATTERIES AND METHODS FOR MAKING THE SAME

(71) Applicant: The Regents of the University of Michigan, Ann Arbor, MI (US)

(72) Inventors: Nicholas A. KOTOV, Ypsilanti, MI (US); Mingqiang WANG, Harbin (CN)

(73) Assignee: The Regents of the University of Michigan, Ann Arbor, MI (US)

(21) Appl. No.: 19/165,877

(22) PCT Filed: Mar. 18, 2024
(86) PCT No.: PCT/US2024/020409

§ 371 Date: Sep. 16, 2025

Related U.S. Application Data
(60) Provisional application No. 63/452,867, filed on Mar. 17, 2023.

(51) Int. Cl. H01M 4/36; H01M 4/04; H01M 4/38; H01M 10/0525

(52) U.S. Cl. CPC H01M 4/364; H01M 4/0471; H01M 4/38; H01M 10/0525; H01M 4/382

(57) ABSTRACT

A lithium-sulfur positive electrode material that can be incorporated into a lithium-sulfur battery includes a sulfur host material configured to receive a sulfur electroactive material that cycles lithium ions. The sulfur host material includes a fibrous carbonaceous network, an electroactive metal associated with the fibrous carbonaceous network, and a plurality of carbon nanotubes formed on the fibrous carbonaceous network. Methods of making a lithium-positive electrode material may include forming a porous membrane from aramid nanofibers, contacting a salt including the electroactive metal with it, contacting a plurality of zeolitic imidazolate framework-67 particles with it, pyrolyzing to form a fibrous carbonaceous network having the electroactive metal, and then forming a plurality of carbon nanoparticles on a plurality of sites in the fibrous carbonaceous network.

### CROSS-REFERENCE TO RELATED APPLICATIONS

This application claims the benefit of U.S. Provisional Application No. 63/452,867 filed on Mar. 17, 2023. The entire disclosure of the above application is incorporated herein by reference.

### GOVERNMENT SUPPORT

This invention was made with government support under 1538180 awarded by the National Science Foundation. The Government has certain rights in the invention.

### FIELD

The present disclosure relates to a positive electrode material for a lithium-sulfur electrochemical cell that includes a hierarchical sulfur host material configured to receive a sulfur electroactive material that cycles lithium ions and to methods of making such positive electrodes.

### BACKGROUND

This section provides background information related to the present disclosure which is not necessarily prior art.

Lithium-sulfur (Li—S) electrochemical cells or batteries are one of most attractive platforms for energy storage in a variety of technological fields due to the high energy density (2600 Whkg⁻¹), large theoretical capacity (1675 mAhg⁻¹), cost effectiveness, and environmental friendliness. However, the practical implementation of Li—S batteries are still impeded by some intractable challenges, mainly originating from the low electrical conductivity of sulfur and its discharge product (Li₂S₂/Li₂S), the shuttle effect of the solubility lithium polysulfides (LiPS:Li₂Sₙ 4≤n≤8), as well as the large volumetric expansion of sulfur electrodes during cycling, which leads to loss of capacity.

Recently, extensive research have been devoted to address these problems, which have included cathode structure optimizations, multifunctional separators, new concepts for electrolyte constructions, and anode protections. For example, the design of positive electrodes or cathodes for Li—S batteries has been a focus. The molecular, nanoscale, and microscale morphology of a sulfur host in the cathode are important for high-efficiency sulfur electrochemistry reactions and enhancement of battery performance. Multifarious sulfur host materials, such as porous carbon, conductive polymers, graphene, carbon nanotube, metal-organic frameworks, metal oxides/sulfides and their hybrids have been employed in attempts to improve the electrochemistry performance of Li—S batteries. The design principle behind these investigations is to impart the sulfur host with accelerated lithium ion (Li⁺) diffusion and electron transport for facile sulfur electrochemical redox reaction, as well as desired sulfur immobilization.

However, there is still a considerable room for improvement in the cycle life and overall performance of Li—S batteries, especially under long cycling and high sulfur loading, due to the relatively weak interactions between sulfur and its Li-intercalates for nonpolar porous carbon, as well as the lower conductivity for inorganic polar materials. Meanwhile, the insufficient surface area and binding interaction sites for most designed sulfur host materials derived from irregular granules or flakes only constrain limited LiPS near the surface and are effective for only low mass sulfur loading, making them severely compromise the energy density of Li—S system, leading to these sulfur host materials being unsuitable for practical applications. Thus, it would be advantageous for the sulfur host material to restrict or minimize the shuttling of LiPS, while providing efficient charge transport for high loading of sulfur that is not conductive. Further breakthroughs are still needed to satisfy the essential requirements for Li—S batteries that combine sufficient sulfur loading, highly reversible specific/areal capacity, high discharge rate capability, reduced shuttling of lithium polysulfides, and operational durability.

### SUMMARY

This section provides a general summary of the disclosure and is not a comprehensive disclosure of its full scope or all of its features.

In certain aspects, the present disclosure relates to an electrode material for an electrochemical cell.

In one aspects, the electrode material may include a fibrous carbonaceous network. A metal such as an electroactive metal, like a transition metal, may be associated with the fibrous carbonaceous network and a plurality of carbon nanotubes may be disposed on the fibrous carbonaceous network.

In one aspect, the plurality of carbon nanotubes may be nitrogen doped.

In certain aspects, the present disclosure further relates to a positive electrode material for a lithium-sulfur electrochemical cell.

In one aspect, the positive electrode may include a sulfur host material configured to receive a sulfur electroactive material that cycles lithium ions. The sulfur host may include a fibrous carbonaceous network. Cobalt (Co) may be associated with the fibrous carbonaceous network and a plurality of carbon nanotubes may be disposed on the fibrous carbonaceous network.

In one aspect, the plurality of carbon nanotubes may be nitrogen doped.

In one aspect, the positive electrode may have an areal capacity of greater than or equal to about 17 mAhcm⁻².

In one aspect, the positive electrode may further include the sulfur electroactive material. For example, the positive electrode may have a sulfur loading of greater than or equal to about 15 mg/cm².

In certain aspects the present disclosure relates to a lithium-sulfur electrochemical cell.

In one aspect, the lithium-sulfur electrochemical cell may include a positive electrode. The positive electrode may include a sulfur host material that is configured to receive a sulfur electroactive material that cycles lithium ions. The sulfur host material may include a fibrous carbonaceous network. Cobalt (Co) may be associated with the fibrous carbonaceous network, and a plurality of carbon nanotubes may be disposed on the fibrous carbonaceous network. The electrochemical cell may also further include a negative electrode. The negative electrode may include lithium. The electrochemical cell may also further include a separator that may be disposed between the positive electrode and the negative electrode. The electrochemical cell may also further include an electrolyte that may be incorporated into at least one of the positive electrode, the negative electrode, and the separator.

In one aspect, the positive electrode may have an areal capacity of greater than or equal to about 17 mAhcm⁻².

In one aspect, the positive electrode may have a sulfur loading of greater than or equal to about 15 mg/cm².

In one aspect, the plurality of carbon nanotubes may be nitrogen doped.

In one aspect, the lithium-sulfur electrochemical cell may have an electrolyte-to-sulfur ratio (E/S) ratio of less than or equal to about 8:1.

In certain aspects, the present disclosure further relates to a method of making a positive electrode for a lithium-sulfur electrochemical cell.

In certain aspects, a method of making an electrode for a lithium-sulfur electrochemical cell may comprise pyrolyzing a porous membrane formed from a plurality of aramid fibers or nanofibers and a plurality of metal organic framework nanoparticles to form a fibrous carbonaceous network. The method may further comprise incorporating a transition metal into the fibrous carbonaceous network and then forming a plurality of carbon nanotubes on a plurality of sites associated with the transition metal in the fibrous carbonaceous network to form a sulfur host material configured to receive a lithium-sulfur electroactive material that cycles lithium ions.

In one aspect, the method further comprises forming the porous membrane by spin coating the plurality of aramid nanofibers and incorporating the plurality of metal organic framework nanoparticles therein.

In one aspect, the metal organic framework nanoparticles comprise a plurality of zeolitic imidazolate framework-67 (ZIF-67) particles and the transition metal comprises cobalt.

In one aspect, the method may include forming a porous membrane from aramid nanofibers, contacting a salt including cobalt with the porous membrane to incorporate cobalt therein, contacting a plurality of zeolitic imidazolate framework-67 (ZIF-67) particles with the porous membrane, and pyrolyzing the porous membrane to form a fibrous carbonaceous network having cobalt associated with the fibrous carbonaceous network. The method may further include forming a plurality of carbon nanoparticles on a plurality of sites, for example corresponding to the cobalt, in the fibrous carbonaceous network that forms a sulfur host material configured to receive a sulfur electroactive material that cycles lithium ions.

In certain aspects the present disclosure relates to an electrode material.

In one aspect, the electrode material may include a sulfur electroactive material and a sulfur host material configured to receive the sulfur electroactive material. The sulfur host material may include a fibrous carbonaceous network, an electroactive metal associated with the fibrous carbonaceous network, and a plurality of carbon nanotubes formed on the fibrous carbonous network.

In one aspect, the electroactive metal may include a transition metal.

In one aspect, the transition metal may include cobalt.

In one aspect, the electroactive material may be adsorbed on a surface of the fibrous carbonaceous network.

In one aspect, the electroactive material may be embedded in the fibrous carbonaceous network.

In one aspect, the electroactive material may be adsorbed on a surface of the fibrous carbonaceous network and embedded in the fibrous carbonaceous network.

In one aspect, the plurality of carbon nanotubes may be formed on the fibrous carbonous network at sites of the electroactive metal.

In one aspect, the plurality of carbon nanotubes may be nitrogen doped.

In one aspect, the electrode material may have an aerial capacity of greater than or equal to about 17 mAhcm⁻².

In one aspect, the electrode material may have a sulfur loading of greater than or equal to about 15 mg/cm².

In certain aspects the present disclosure relates to a lithium-sulfur electrochemical cell.

In one aspect, the lithium-sulfur electrochemical cell may include a positive electrode, a negative electrode, a separator disposed between the positive electrode and the negative electrode, and an electrolyte incorporated into at least one of the positive electrode, the negative electrode, and the separator The positive electrode may include a sulfur electroactive material and a sulfur host material configured to receive the sulfur electroactive material. The sulfur host material may include a fibrous carbonaceous network, an electroactive metal associated with the fibrous carbonaceous network, and a plurality of carbon nanotubes formed on the fibrous carbonous network. The negative electrode may include lithium.

In one aspect, the electroactive metal may include a transition metal.

In one aspect, the electroactive material may be adsorbed on a surface of the fibrous carbonaceous network, the electroactive material may be embedded in the fibrous carbonaceous network, or the electroactive material may be adsorbed on a surface of the fibrous carbonaceous network and embedded in the fibrous carbonaceous network.

In one aspect, the plurality of carbon nanotubes may be formed on the fibrous carbonous network at sites of the electroactive metal.

In one aspect, the plurality of carbon nanotubes may be nitrogen doped.

In one aspect, the positive electrode may have an areal capacity of greater than or equal to about 17 mAhcm⁻² and a sulfur loading of greater than or equal to about 15 mg/cm².

In one aspect, the lithium-sulfur electrochemical cell may have an electrolyte-to-sulfur ratio (E/S) ratio of less than or equal to about 8:1.

In certain aspects the present disclosure relates to a method of making an electrode for a lithium-sulfur electrochemical cell.

In one aspect, the method may include contacting a salt that includes an electroactive metal with a porous membrane, contacting an aerogel precursor with the porous membrane, pyrolyzing the porous membrane to form a fibrous carbonaceous network having the electroactive metal associated with the fibrous carbonaceous network, and forming a plurality of carbon nanoparticles on a plurality of sites in the fibrous carbonaceous network that forms a sulfur host material configured to receive a sulfur electroactive material that cycles lithium ions.

In one aspect, the method may further include forming the porous membrane. The porous membrane may include aramid nanofibers.

In one aspect, the aerogel precursor may include a plurality of zeolitic imidazolate framework-67 (ZIF-67) particles.

Further areas of applicability will become apparent from the description provided herein. The description and specific examples in this summary are intended for purposes of illustration only and are not intended to limit the scope of the present disclosure.

### DRAWINGS

The drawings described herein are for illustrative purposes only of selected embodiments and not all possible implementations and are not intended to limit the scope of the present disclosure.

FIGS. 1A-1G. FIG. 1A is a schematic illustrating an example synthesis of a sulfur host material configured to receive the sulfur electroactive material, where the sulfur host material includes a fibrous carbonaceous network formed from a network of aramid nanofibers (ANF) with nanoparticles (NPs) of a metal organic framework, such as a zeolitic imidazolate framework (e.g., ZIF-67) that may be self-assembled on the surface of the ANF, with an electroactive metal (such as cobalt) associated with the fibrous carbonaceous network, that thus forms a plurality of carbon nanotubes on the fibrous carbonous network (NCZC) in accordance with various aspects of the present disclosure. FIGS. 1B and 1C are scanning electron microscope images of ANF aerogel membranes at 500 nm and 200 nm scale respectively, prepared in accordance with various aspects of the present disclosure. FIGS. 1D and 1E are scanning electron microscope images of ANF@ZIF-67 at 500 nm and 200 nm scale respectively, in accordance with various aspects of the present disclosure. FIGS. 1F and 1G are scanning electron microscope images of NCZC at 500 nm and 200 nm scale respectively, in accordance with various aspects of the present disclosure.

FIGS. 2A-2H. FIGS. 2A-2E are transmission electron microscope images of NCZC composites in accordance with various aspects of the present disclosure showing growth of multiwalled N-CNTs with highly graphitic walls with inner and outer diameters, cobalt, and lattice spacing. FIG. 2A has a scale of 500 nm, FIG. 2B has a scale of 200 nm, FIG. 2C has a scale of 20 nm and FIG. 2D has a scale of 5 nm. FIG. 2E has a scale of 5 nm and the circled regions are shown in more detail on the right at top and bottom. FIG. 2F is a high-resolution x-ray photoelectron spectra of carbon (Cₗₛ) (see FIG. 2B) in accordance with various aspects of the present disclosure. FIG. 2G is a high-resolution x-ray photoelectron spectra of nitrogen (N₁ₛ) (see FIG. 2C) in accordance with various aspects of the present disclosure. FIG. 2H is a high-resolution x-ray photoelectron spectra of cobalt (CO₂ₚ) (see FIG. 2D) in accordance with various aspects of the present disclosure.

FIGS. 3A-3G. FIG. 3A is a graphical demonstration illustrating a voltage profile comparing the inventive NCZC electrode with reduced graphene oxide (rGO), and Co-embedded porous carbon framework (CoCF) electrodes at a rate of 0.2C (1C=1675 mAg⁻¹) with a controlled sulfur loading of 3.84 mg cm⁻², where the x-axis represents capacity and the y-axis represents voltage, in accordance with various aspects of the present disclosure. FIG. 3B is a graphical demonstration illustrating cycling performance comparing NCZC, rGO, and CoCF electrodes at a rate of 0.2C (1C=1675 mAg⁻¹) with a controlled sulfur loading of 3.84 mg cm⁻², where the x-axis represents cycle number, the y₁-axis represents capacity, and the y₂-axis represents coulombic efficiency, in accordance with various aspects of the present disclosure.

FIG. 3C is a graphical demonstration illustrating rate performance comparing NCZC, rGO, and CoCF based Li—S batteries ranged scan rate from 0.2C to 10C (1C=1675 mAg⁻¹), where the x-axis represents cycle number and the y-axis represents capacity, in accordance with various aspects of the present disclosure. FIG. 3D is a graphical demonstration illustrating Galvanostatic charge-discharge profiles comparing NCZC, rGO, and CoCF based Li—S batteries ranged scan rate from 0.2C to 10C (1C=1675 mAg⁻¹), where the x-axis represents capacity and the y-axis represents voltage, in accordance with various aspects of the present disclosure. FIG. 3E is an electrochemical impedance spectra comparison of NCZC, rGO, and CoCF electrode in accordance with various aspects of the present disclosure. FIG. 3F is a graphical demonstration illustrating a capacity decay per cycle with carbon-based electrode originated from various Metal-Organic Framework (MOF) nanoparticles. FIG. 3G is a graphical demonstration illustration long-term cycling performance of NCZC electrode over 2500 cycles at rate of 1.0 C, where the a-axis represents cycle number, the y₁-axis represents capacity, and the y₂-axis represents columbic efficiency, in accordance with various aspects of the present disclosure.

FIGS. 4A-4E. FIG. 4A is a schematic illustrating optimized configurations for the binding of Li₂S_{X} (1≤x≤8) to the NCZC sulfur host material of C—Co—N in accordance with various aspects of the present disclosure. FIG. 4B is a graphical demonstration illustrating binding energies (Eb) for the Li₂S_{X} (1≤x≤8) on comparative rGO, comparative N-doped carbon, and inventive NCZC electrodes composed of C—Co—N prepared in accordance with various aspects of the present disclosure. FIG. 4C is a graphical demonstration illustrating an ultraviolet/visible absorption spectra of a Li₂S₄ solution before and after the addition of rGO and NCZC, where the inset photograph is optical photograph of the Li₂S₄ trapping by rGO and NCZC after 24 hours. FIGS. 4D and 4E are high-resolution XPS S₂p and Li₁ₛ spectra before and after adsorption of Li₂S₄, where the x-axis represents binding energies and the y-axis represents intensity, in accordance with various aspects of the present disclosure.

FIGS. 5A-5E. FIG. 5A is a graphical demonstration illustrating the areal capacities of NCZC electrodes with various sulfur loadings prepared in accordance with various aspects of the present disclosure, where the x-axis represents cycle number and the y-axis represents areal capacity. FIG. 5B is a graphical demonstration illustrating comparisons between sulfur loading and areal capacity between NCZC and representative high sulfur loading (e.g., more than 5 mgcm⁻²) electrodes, where the x-axis represents sulfur loading and the y-axis represents areal capacity, in accordance with various aspects of the present disclosure. FIG. 5C is a graphical demonstration illustrating rate performance of NCZC electrode prepared in accordance with various aspects of the present disclosure at various rates from 0.2C-5.0C with a high sulfur loading of 15.4 mgcm⁻², where the x-axis represents cycle number, the y₁-axis represents capacity, and the y₂-axis represents areal capacity. FIG. 5D is a graphical demonstration illustrating Galvanostatic charge/discharge profiles of NCZC electrode at various rates from 0.2C-5.0C with a high sulfur loading of 15.4 mgcm⁻², where the x₁-axis represents capacity, the x₂-axis represents areal capacity, and the y-axis represents voltage, in accordance with various aspects of the present disclosure. FIG. 5E is a graphical demonstration illustrating cycling stability of NCZC electrode with a high sulfur loading of 15.4 mgcm⁻² at the rate of 0.2 C and the corresponding areal capacities, where the x-axis represents cycle number, the y₁-axis represents areal capacity, y₂ axis represents capacity, and the y₃-axis represents columbic efficiency, in accordance with various aspects of the present disclosure.

FIG. 6 is a graphical demonstration illustrating charge/discharge curves of NCNC-based lithium-sulfur batteries prepared in accordance with various aspects of the present disclosure from 1st to 100th cycles, where the x-axis represents capacity and the y-axis represents voltage.

FIGS. 7A-7D. FIGS. 7A and 7B are scanning electron microscope images at 300 nm and 200 nm scale respectively, of ANF nanofiber after calcining in N₂ atmosphere at 700° C. in accordance with various aspects of the present disclosure. FIGS. 7C and 7D transmission electron microscope images at 100 nm and 10 nm scale respectively, of ANF nanofiber after calcining in N₂ atmosphere at 700° C. in accordance with various aspects of the present disclosure.

FIG. 8 is a schematic illustrating optimized configurations for the binding of lithium polysulfides (Li₂S_{X} (1≤x≤8)) to the NCZC HFN of Pyridinic N in accordance with certain aspects of the present disclosure as compared to association with comparative rGO.

Corresponding reference numerals indicate corresponding parts throughout the several views of the drawings.

### DETAILED DESCRIPTION

Example embodiments are provided so that this disclosure will be thorough and will fully convey the scope to those who are skilled in the art. Numerous specific details are set forth such as examples of specific compositions, components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known processes, well-known device structures, and well-known technologies are not described in detail.

The terminology used herein is for the purpose of describing particular example embodiments only and is not intended to be limiting. As used herein, the singular forms “a,” “an,” and “the” may be intended to include the plural forms as well, unless the context clearly indicates otherwise. The terms “comprises,” “comprising,” “including,” and “having,” are inclusive and therefore specify the presence of stated features, elements, compositions, steps, integers, operations, and/or components, but do not preclude the presence or addition of one or more other features, integers, steps, operations, elements, components, and/or groups thereof. Although the open-ended term “comprising,” is to be understood as a non-restrictive term used to describe and claim various embodiments set forth herein, in certain aspects, the term may alternatively be understood to instead be a more limiting and restrictive term, such as “consisting of” or “consisting essentially of.” Thus, for any given embodiment reciting compositions, materials, components, elements, features, integers, operations, and/or process steps, the present disclosure also specifically includes embodiments consisting of, or consisting essentially of, such recited compositions, materials, components, elements, features, integers, operations, and/or process steps. In the case of “consisting of,” the alternative embodiment excludes any additional compositions, materials, components, elements, features, integers, operations, and/or process steps, while in the case of “consisting essentially of,” any additional compositions, materials, components, elements, features, integers, operations, and/or process steps that materially affect the basic and novel characteristics are excluded from such an embodiment, but any compositions, materials, components, elements, features, integers, operations, and/or process steps that do not materially affect the basic and novel characteristics can be included in the embodiment.

Any method steps, processes, and operations described herein are not to be construed as necessarily requiring their performance in the particular order discussed or illustrated, unless specifically identified as an order of performance. It is also to be understood that additional or alternative steps may be employed, unless otherwise indicated.

When a component, element, or layer is referred to as being “on,” “engaged to,” “connected to,” or “coupled to” another element or layer, it may be directly on, engaged, connected or coupled to the other component, element, or layer, or intervening elements or layers may be present. In contrast, when an element is referred to as being “directly on,” “directly engaged to,” “directly connected to,” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

Although the terms first, second, third, etc. may be used herein to describe various steps, elements, components, regions, layers and/or sections, these steps, elements, components, regions, layers and/or sections should not be limited by these terms, unless otherwise indicated. These terms may be only used to distinguish one step, element, component, region, layer or section from another step, element, component, region, layer or section. Terms such as “first,” “second,” and other numerical terms when used herein do not imply a sequence or order unless clearly indicated by the context. Thus, a first step, element, component, region, layer or section discussed below could be termed a second step, element, component, region, layer or section without departing from the teachings of the example embodiments.

Spatially or temporally relative terms, such as “before,” “after,” “inner,” “outer,” “beneath,” “below,” “lower,” “above,” “upper,” and the like, may be used herein for ease of description to describe one element or feature's relationship to another element(s) or feature(s) as illustrated in the figures. Spatially or temporally relative terms may be intended to encompass different orientations of the device or system in use or operation in addition to the orientation depicted in the figures.

Throughout this disclosure, the numerical values represent approximate measures or limits to ranges to encompass minor deviations from the given values and embodiments having about the value mentioned as well as those having exactly the value mentioned. Other than in the working examples provided at the end of the detailed description, all numerical values of parameters (e.g., of quantities or conditions) in this specification, including the appended claims, are to be understood as being modified in all instances by the term “about” whether or not “about” actually appears before the numerical value. “About” indicates that the stated numerical value allows some slight imprecision (with some approach to exactness in the value; approximately or reasonably close to the value; nearly). If the imprecision provided by “about” is not otherwise understood in the art with this ordinary meaning, then “about” as used herein indicates at least variations that may arise from ordinary methods of measuring and using such parameters. For example, “about” may comprise a variation of less than or equal to 5%, optionally less than or equal to 4%, optionally less than or equal to 3%, optionally less than or equal to 2%, optionally less than or equal to 1%, optionally less than or equal to 0.5%, and in certain aspects, optionally less than or equal to 0.1%.

In addition, disclosure of ranges includes disclosure of all values and further divided ranges within the entire range, including endpoints and sub-ranges given for the ranges.

Example embodiments will now be described more fully with reference to the accompanying drawings.

High-energy density electrochemical cells, such as lithium-sulfur (LiS) batteries can be used in a variety of applications. Typical lithium-sulfur batteries include at least one positive electrode or cathode, at least one negative electrode or an anode, an electrolyte material, and a separator. Lithium-sulfur batteries operate by reversibly passing lithium ions between the negative electrode and the positive electrode. The positive electrode typically includes a sulfur host material that contains sulfur/sulfur compounds that reversibly react with lithium, while the negative electrode may be a lithium metal. A separator, such as a polymeric separator, may be disposed between the negative and positive electrodes. A liquid or solid electrolyte is also disposed between the positive and negative electrodes. For example, the liquid or solid electrolyte may be disposed in pores of a separator. Electrolytes suitable for conducting lithium ions between the electrodes and may be in solid and/or liquid form and/or a hybrid thereof. In instances of solid-state batteries, which include solid-state electrodes and a solid-state electrolyte (or solid-state separator), the solid-state electrolyte (or solid-state separator) may physically separate the electrodes such that a distinct separator may not be required.

Lithium ions move between the cathode (positive electrode) and the anode (negative electrode) in a first direction when charging the battery and in the opposite direction when discharging the battery. Each negative and positive electrode is connected to a current collector. During battery usage, the current collectors associated with the two electrodes are connected by an external circuit that allows current generated by electrons to pass between the electrodes to compensate for transport of lithium ions.

Low conductivity of sulfur and small molecular size of lithium polysulfides create fundamental difficulties for lithium-sulfur batteries to attain cyclability, discharge rate, and Coulombic efficiency compared with semiconductive metal oxides. Based on the previous studies of charge, mass, and stress transport in percolating networks, the present disclosure addresses such challenges by providing a new positive electrode material having a sulfur host material with a hierarchical architecture.

In certain aspects, a positive electrode material for a lithium-sulfur electrochemical cell is provided. The positive electrode or cathode may include a sulfur host material configured to receive a sulfur electroactive material that cycles lithium ions. The hierarchical sulfur host material may include a fibrous carbonaceous network. The fibrous carbonaceous network may be formed by pyrolyzing an aerogel precursor created from aromatic polyamide or aramid nanofibers (referred to herein as PAF or ANF). In certain variations, the aerogel precursor having the ANF fibers may also have a plurality of metal organic framework (MOF) particles, such as zeolitic imidazolate framework-67 (ZIF-67) particles, disposed on or mixed with the ANF fibers. Further, the fibrous carbonaceous network has cobalt (Co) metal associated therewith, for example, cobalt may be adsorbed on the surface of the fibrous carbonaceous network or embedded into the fibrous carbonaceous network. The cobalt may be provided on the surface of the fibrous carbonaceous network as a nanoparticle, for example, in one variation, having an average diameter of about 20 nanometers. In certain variations, the reagents or conditions during pyrolysis may facilitate nitrogen (N)-doping of the carbon-based material (generated by pyrolyzing the aramid fibers).

After pyrolysis of the aerogel precursor, a plurality of carbon structures may be formed on the fibrous carbonaceous network, for example, being grown from a plurality of sites on surface of the fibrous carbonaceous network by a deposition process like chemical vapor deposition (CVD). In certain aspects, the carbon structures are carbon nanotubes formed on the fibrous carbonaceous network, such as multiwalled carbon nanotubes (MWCNT) or in alternative aspects, single walled carbon nanotubes (SWCNT). The sites may correspond to a portion of the cobalt present on the surface and serve as a catalyst to being growth of a nanotube therefrom. In certain variations, the carbon nanotubes are grown in an environment that promotes nitrogen (N)-doping of the carbon nanotube.

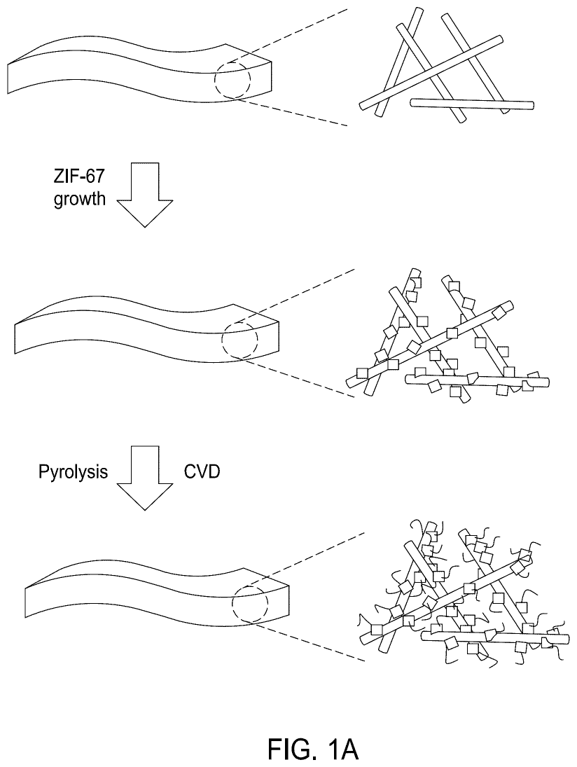

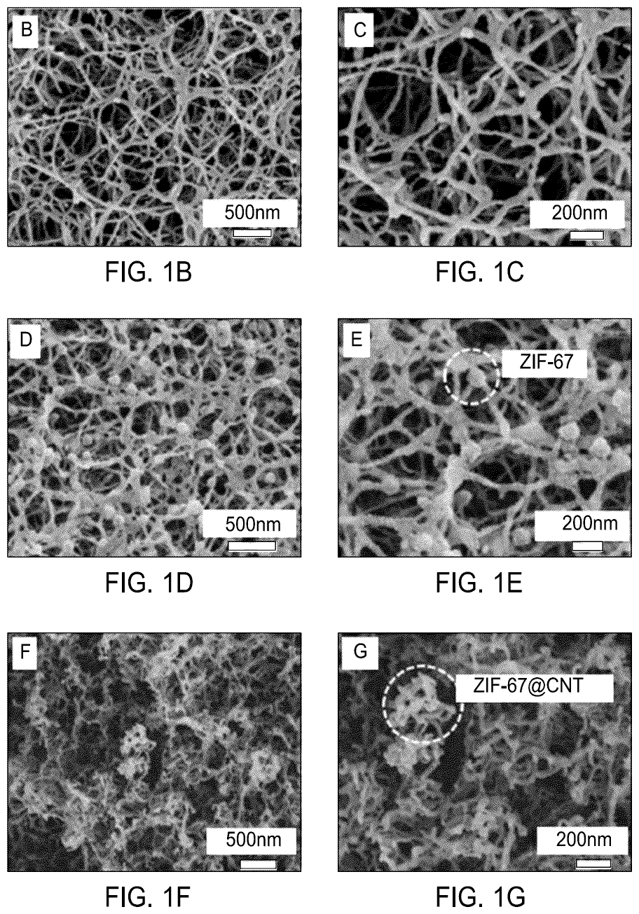

In this hierarchical sulfur host material, high connectivity and conductivity of N-doped carbonized aramid nanofibers accommodating cobalt (Co) nanoparticles (e.g., having an average diameter of less than about 20 nanometers) and N-doped carbon nanotubes (CNT) create a multiscale network capable of efficient charge transport, minimal dead volume, and strong binding of lithium polysulfides. More specifically, a composite material may be formed having a structure engineered in multiple scales that includes an interconnected N-doped carbon nanofiber framework (NCNF), cobalt-embedded porous carbon framework (CoCF) hybrids derived from aramid nanofibers (ANFs), and N-doped carbon nanotubes (N-CNTs) rooted or attached to the CoCF. During synthesis, metal organic framework nanoparticles, like ZIF-67 nanoparticles, may be assembled onto fibrous aerogel skeleton formed from aramid nanofibers (ANF) through electrostatic attraction and coordination bonding, while the N-CNTs may be subsequently grown via a chemical vapor deposition (CVD) to further intertwine the nanofibers and form a highly interconnected free-standing conductive framework (see FIG. 1A).

FIG. 1A shows the first steps in a method of making a positive electrode for a lithium-sulfur electrochemical cell that will be further described below. In FIG. 1A, at the top, a porous membrane is formed from aramid nanofibers, for example, by spin casting. This may be processed to form an aerogel porous membrane. Next, a plurality of zeolitic imidazolate framework-67 (ZIF-67) particles are contacted with or grown on the porous aerogel membrane. The precursor may then be pyrolyzed to form a fibrous carbonaceous network.

In certain variations, free-standing aramid nanofiber (ANF) membranes serving as a cathode base were prepared via spin-coating (see FIGS. 1B and 1C). Then, ANF aerogel membrane may be immersed into a solution of Co(NO₃)₂·6H₂O in methanol where Co²⁺ ions adsorb onto the nanofibers forming coordination bonds with amide group. Afterwards, nanoparticles (NPs) of zeolitic imidazolate framework-67 (ZIF-67) may be self-assembled on the surface of ANF (ZIF@ANF) as indicated by Scanning Electron Microscopy (SEM) (see FIGS. 1D and E). The concentration of ZIF-67 on ANF@ ZIF precursors can vary by immersion time (e.g., 1 hour, 2 hours, 3 hours, and 4 hours). As the soaking time is extended, the cubic NPs also nucleated in the solution and formed in the voids between the nanofibers (ANF@ ZIF-4).

The multiscale network composite was obtained by catalytic CVD carbonization in a nitrogen (N₂) atmosphere. In this process, the ZIF@ANF may be pyrolyzed and transformed into a cobalt-containing/embedded porous carbon framework (CoCF) and interconnected N-doped carbon nanofiber framework (NCNF) (CoCF@NCNF). In certain aspects, the N-doped carbon aerogel @ Co-embedded hierarchical carbon hybrids @ CNT (denoted as HFN) composite electrode material may be fabricated by employing chemical vapor deposition (CVD) technique, which may include thermal annealing of ANF@ZIF by using melamine as precursor without any additional catalysts. When the melamine starts to decompose, it is accompanied by NH₃ and H₂ release. These gases contribute to the formation of active Co nanoparticles and promote the catalytic growth of N-CNTs on the surface from abundant carbon and nitrogen sources. CoCF acquired morphologies originating from the catalytic growth of N-CNTs (see FIGS. 1F and 1G). Unlike the carbon nanofibers derived from ANF with a smooth surface, the fibers in NCZC have a rough surface with abundant bamboo-like N-CNT growth. The surface density of ZIF-67 NPs affects the morphology of the carbonized composite. For example, NCZC-4 is less uniform than NCZC-3 due to higher ZIF-67 NP content. In the absence of melamine, the N-CNTs disappeared after annealing.

The sulfur host material made by such processes and provided by various aspects of the present disclosure has several structural features advantageous for the integration into multiple transport requirements. For example, the highly 3D interconnected continuous carbon nanofiber network architecture provides uniform sulfur distribution, fast electron conduction, and adequate electrode/electrolyte interfaces for rapid ion transfer. Further, the porous carbon units, as well as N-CNTs growth, spread throughout the inner space of fibrous network offering more active sites for redox processes with sulfur, which is particularly useful for high sulfur loading system. Further still, the polar surface with uniformly distributed nitrogen (N)- and cobalt (Co)-doping facilitates confinement of the lithium polysulfides (LiPS), helping to minimize or prevent LiPS shuttling. Further still, the free-standing electrode design has a large surface area, circumvents insulative polymer binder, and thus further enhances the conductivity of the electrode, as well as accommodates the sulfur species against their volumetric change during the battery cycling process.

In certain aspects, lithium-sulfur batteries incorporating such cathodes demonstrate a high rate capability up to 10C, a negligible capacity attenuation of 0.011% per cycle over an ultralong cycling process (e.g., over 2,500 charge/discharge cycles) and high areal capacity of 17.0 mAhcm⁻² at a high sulfur loading up to about 15.4 mg cm⁻² with a low electrolyte-to-sulfur ratio (E/S) ratio of about 8:1 making the batteries incorporating these positive electrodes highly suitable for many practical applications. These electrochemical parameters exceed leading commercial batteries with metal oxide cathodes by greater than or equal to about 300% to less than or equal to about 500% and DOE targets for electrical vehicle batteries by 300%.

In various aspects, the present disclosure provides a lithium-sulfur electrochemical cell including a positive electrode that includes a sulfur host material configured to receive a sulfur electroactive material that cycles lithium ions. The sulfur host material may include a fibrous carbonaceous network. Cobalt (Co), for example, cobalt nanoparticles, may be associated with the fibrous carbonaceous network. Further, the sulfur host material may include a plurality of carbon nanotubes formed on the fibrous carbonaceous network. The lithium-sulfur electrochemical cell may also include a negative electrode that includes lithium, a separator disposed between the positive electrode and the negative electrode, and an electrolyte.

In one aspect, the lithium-sulfur electrochemical cell may have an areal capacity of greater than or equal to about 17.0 mAhcm⁻². In another aspect, the lithium-sulfur electrochemical cell may have a sulfur loading of greater than or equal to about 15.3 mg/cm². In yet another aspect, an electrolyte-to-sulfur ratio (E/S) ratio of the electrochemical cell may be less than or equal to about 8:1.

The hierarchical networks design based on graph theoretical description of the nanofiber composites can also be extended to other materials for sustainable energy technologies requiring high efficiency of charge transport and mechanical robustness.

It will be further appreciated that the porous hierarchical electrode materials may be used in other applications, aside from lithium-sulfur batteries. These may include by way of non-limiting example, other energy storage such as supercapacitors, metal-ion or metal-air batteries, and the like. In such applications, the electrode may include a porous material configured to receive an electroactive material that cycles lithium ions. The porous material may include a fibrous carbonaceous network and have one or more electroactive metals (e.g., transition metals like cobalt (Co), manganese (Mn), nickel (Ni), aluminum (Al)) associated with the fibrous carbonaceous network. Further, the porous material has plurality of carbon nanotubes formed on the fibrous carbonaceous network. The plurality of carbon nanotubes and/or the fibrous carbonaceous network may be doped with nitrogen (N).

Embodiments of the present disclosure are further illustrated through the following non-limiting examples.

### Example 1

Preparation of ANF Hydrogels Membranes. An aramid nanofiber (ANFs) dispersion was prepared according to J. Zhu et al., “Branched aramid nanofibers.” Angew. Chemie Int. Ed. 56, 11744-11748 (2017), the relevant portions of which are incorporated herein. In this example, a 2 wt. % ANF dispersion was used by stirring KEVLAR™ 69 (from Thread Exchange) in dimethyl sulfoxide (DMSO, Sigma Aldrich ≥99.9%) for one week in the presence of Potassium hydroxide (KOH, Sigma Aldrich) until a dark red ANF solution was obtained. The spin coating method was then used to prepare ANF hydrogels membrane. Specifically, 2 mL of ANF (2 wt. %) dispersion was dipped on a clean glass slide and spin-coated at about 1500 rpm for about 30 seconds. After that, the glass slides were immersed into deionized water to remove the DMSO and then stored in methanol (Sigma Aldrich) solution for later use. It should be noted that prior to use, the glass slides were cleaned in piranha solution (3:1 H₂SO₄/H₂O₂) for about 24 hours, followed by thorough rinsing with deionized water.

### Example 2

Preparation of ANF@ZIF-67 Composite Aerogel Membranes. To prepare an ANF@ZIF-67 composite membranes, ANF membranes (4 centimeters×4 centimeters) were first immersed into 20.0 mM, 9 mL Co(NO₃)₂·6H₂O (≥99.0%, Sigma Aldrich)/methanol solution for about 10 minutes. Subsequently, about 160.0 mM 15 mL 2-methylimidazole (99.0%, Sigma Aldrich)/methanol was added into the above solution combining with strong magnetic stirring around for about 10 minutes. The ANF membrane was then kept in the purple solution with various time (e.g., 1 hour, 2 hours, 3 hours, and 4 hours) at room temperature. The as-obtained ANF@ZIF with different reaction time (denoted as ANF@ZIF-1, ANF@ZIF-2, ANF@ZIF-3, and ANF@ZIF-4, respectively) were washed with methanol three times to remove excess ZIF-67 nanoparticle (NPs), and subsequently dried via freeze-drying method. For comparison, ZIF-67 nanoparticle (NPs) were also prepared under the same conditions (kept for about 3 hours) without ANF membrane.

### Example 3

Preparation of HFN Composite. An HFN composite according to certain aspects of the present disclosure was fabricated by employing chemical vapor deposition (CVD) technique via the thermal annealing process of ANF@ZIF by using melamine as precursor without any additional catalysts. ANF@ZIF composite serving as templates were placed in a ceramic boat associated with a certain amount of melamine (the mass ratio of melamine/ANF@ZIF=10:1), and subsequently carbonized at about 700° C. for about 1 hour at a gradual heating rate of 2° C. min⁻¹ under N₂ atmosphere (see FIGS. 7A-7D).

### Example 4

Materials Characterization. Scanning electron microscope (SEM, FEI Nova Nanolab dual-beam FIB) and transmission electron microscope (TEM, JEOL JEM-2010 operating at 200 kV) were performed to observe the morphology of ANF, ANF@ZIF and HFN. The x-ray diffraction patterns (XRD, D/Max-2550 PC rotating anode X-ray generator with Cu Ka radiation between about 5° and about 60° at a scan rate of 2°/min), Raman spectra (WITEC Alpha 300 S micro Raman system with a 488 nm laser under ambient conditions), X-ray photoelectron spectroscopy (XPS, RBD upgraded PHI-5000C ESCA, with monochromatic Al Ka (1486.6 eV) radiation) and Thermogravimetric Analyzer (TGA, TA Instruments Discovery, with a temperature ramp to 500° C. at 10° C. min⁻¹ at air atmosphere at a flow rate of 30 mL min⁻¹). The specific surface area of HFN was measured with nitrogen adsorption/desorption isotherms (Micromeritics ASAP 2020 V3.00 H) method using Brunauer-Emmett-Teller (BET) theory. Ultraviolet-visible absorption spectroscopy analysis was carried out to evaluate the polysulfide adsorption capability of conventional rGO and an inventive HFN example. About 4 milligrams each of rGO, HFN were separately put into sealed vials of Li₂S₄ solution (4 mL each, 0.1 mmol L⁻¹), and the pure Li₂S₄ solution was used as a reference. After absorption for 24 h, the ultraviolet-visible absorption spectra of these solutions were tested with an Evolution 300 UV-vis spectrophotometer with baseline correction. The Li₂S₄ was prepared by a synproportionation reaction between Li₂S (99.9%, Sigma Aldrich) and sulfur (99.5%, Sigma Aldrich) with a mole ratio of 1:3 in DOL/DME (v:v=1:1) solution.

### Example 5

Electrochemical Measurements. The electrolyte of Li—S battery was prepared by dissolving lithium trifluoromethanesulfonate (LiCF₃SO₃, 98%, Sigma Aldrich, 1M) and LiNO₃ (99%, Sigma Aldrich, 2 wt. %) in DME (99%, Sigma Aldrich) and DOL (99.5%, Sigma Aldrich) (v:v=1:1). The cells (Standard CR2032 coin cell) were prepared in an Ar-filled glove box. Before assembling the batteries, the sulfur host of HFN cathode was dried at 80° C. under vacuum drying oven for 12 h. The HFN was shaped into plates to be acted as cathode directly with an area of 1.0 cm×1.0 cm.

The various sulfur cathodes were fabricated by dropping the 0.5M S/CS₂ solution into the prepared host substrate, followed by drying at about 60° C. for about 6 hours and thermally treating at about 155° C. for about 12 hours to obtain CoCF @S, rGO @S, and HFN @S electrode. The areal sulfur content was controlled at around 3.84 mg cm⁻² for regular electrodes, while higher sulfur contents of 7.68, 11.52, 15.35 and 19.20 mg cm⁻² were also fabricated via increasing the amount of S/CS₂ solution. The CELGARD™ 2400 and the pure lithium foil were used as separator and anode, respectively. The electrolyte contains 1M LiTFSI in DME/DOL (v:v=1:1) solution with 2 wt. % LiNO₃ as additive. The total electrolyte/sulfur ratio was controlled at 8:1 (μL mg⁻¹). The assembled coin cells were measured in galvanostatic mode at different currents within a voltage range of 1.7-2.8 V (versus Li/Li⁺) at room temperature using LAND-CT2001A battery-testing instrument. The current rate set was varied from 0.2C to 10C (1C-1675 mAg⁻¹). The EIS performed in the range from 100 kHz to 0.05 Hz with potential amplitude of 20 mV.

Density functional theory (DFT) was conducted to calculate the binding energy (Eb) between the HFN and the LiPS, which is defined by:

$${E}_{b} = {E}_{s + NCZC} - {E}_{s} - {E}_{NCZC}$$

where E_{s+HFN}, Eₛ, and EHEN are the energy of the LiPS—HFN, LiPS, and HFN, respectively. The initial conformation of all molecules was obtained by molecular mechanics (MM) method (Forcite module). The DFT calculations were conducted in the Dmol3 module of Accelrys Material Studio.

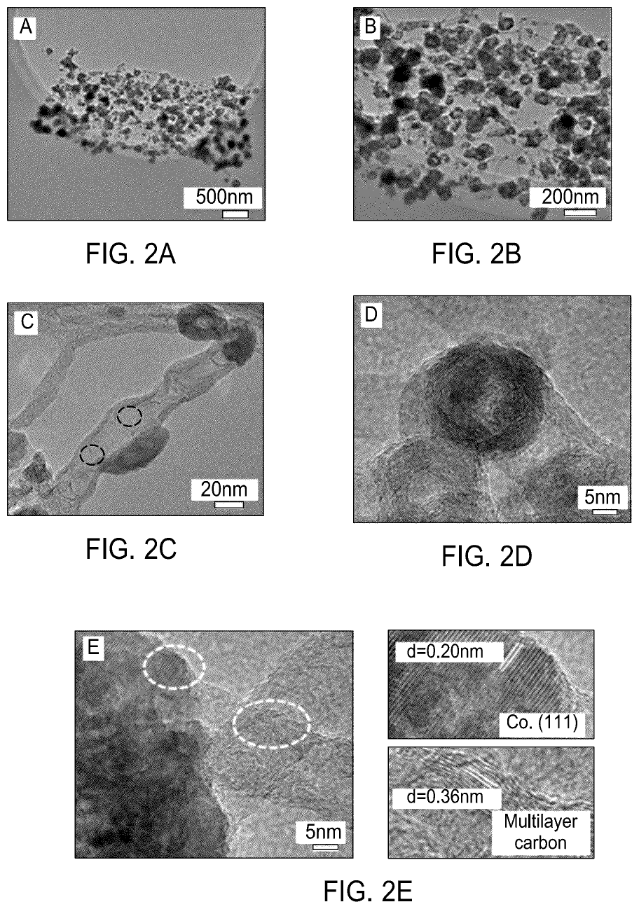

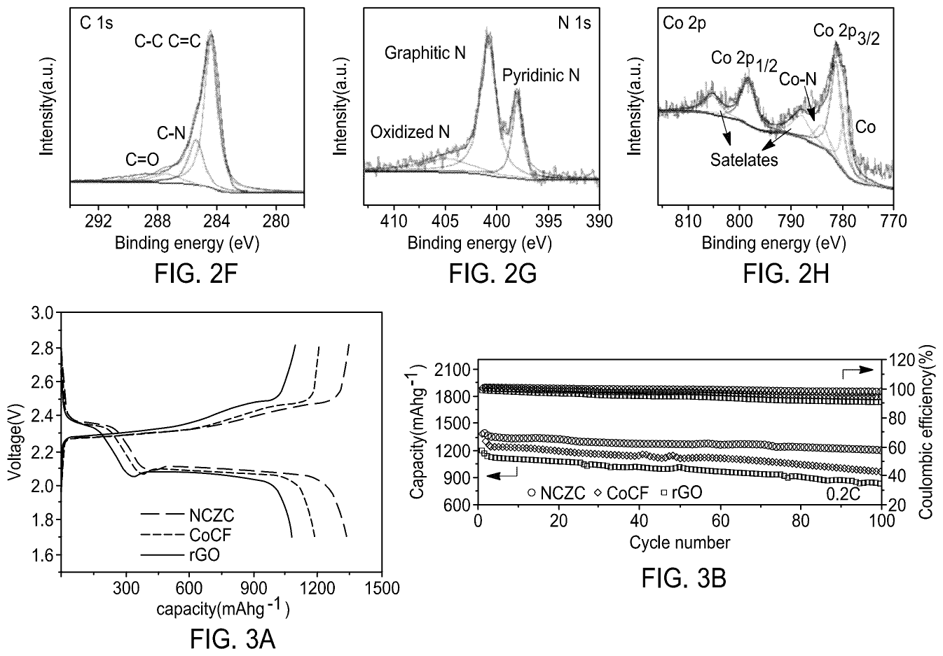

From the transmission electron microscope (TEM) images (see FIGS. 2A-2E), the growth of multiwalled N-CNTs with highly graphitic walls was observed, which have outer diameters ranging from about 5 nanometers to about 10 nanometers and inner diameters of approximately 15 nanometers. Some randomly stacked carbon layers suggests more defects and edges in the N-CNTs (see FIG. 2C, circled area). In particular, large amounts of 20 nanometers NPs were detected between N-CNTs. The lattice spacing of 0.20 nanometer indicates that these regions are Co derived from Co²⁺ in ZIF-67 at high temperature (see FIGS. 2D and 2E), consistent with XRD and Raman characterization.

NCZC exhibits a high specific surface area of 653 m²g⁻¹ and high pore volume with the pore sizes mostly below 10 nanometers based on Brunauer-Emmett-Teller (BET) analysis, which potentially effectively strengthens the sulfur loading, electrolyte permeation along with the confinement and conversion of LiPS. Analysis by X-ray photoelectron spectroscopy (XPS) verifies the presence of Co and N in NCZC, which have characteristic peaks at about 780 eV and about 399 eV, respectively. From the Cls spectra of the NCZC (see FIG. 2F), the existence of C—N bonds confirms that N atoms have been successfully doped into the graphitic domains. N-doped carbon materials are known to have high electrical conductivity and strong affinity for LiPS. From the Nls XPS peaks, three types of N which includes pyridinic N (398.1 eV), graphitic N (400.8 eV), and oxidic N (404.9 eV) are observed (see FIG. 2G). Undoubtedly, the various N peaks derived from the decomposition of ANF network, ZIF-67, as well as melamine. The peak at 783.1 eV in FIG. 2H is representative of Co—Nₓ species, which is generally detected in Co-containing N-doped carbon composite. The presence of CO_{2p1/2} (796.1 eV) and CO_{2p3/2} (780.4 eV) in the Co₂ₚ spectra of NCZC signify that most of the Co exists in oxidized states, largely due to the oxidization of the Co NPs in air. From the thermogravimetric analysis (TGA) analysis, about 25.3 wt. % Co is contained in the NCZC-3. The abundant polar sites in this composite are expected to facilitate redox kinetics of sulfur species inside the porous carbon network, and synergistically contributes to inhibition of shuttle of soluble LiPS away from the cathode.

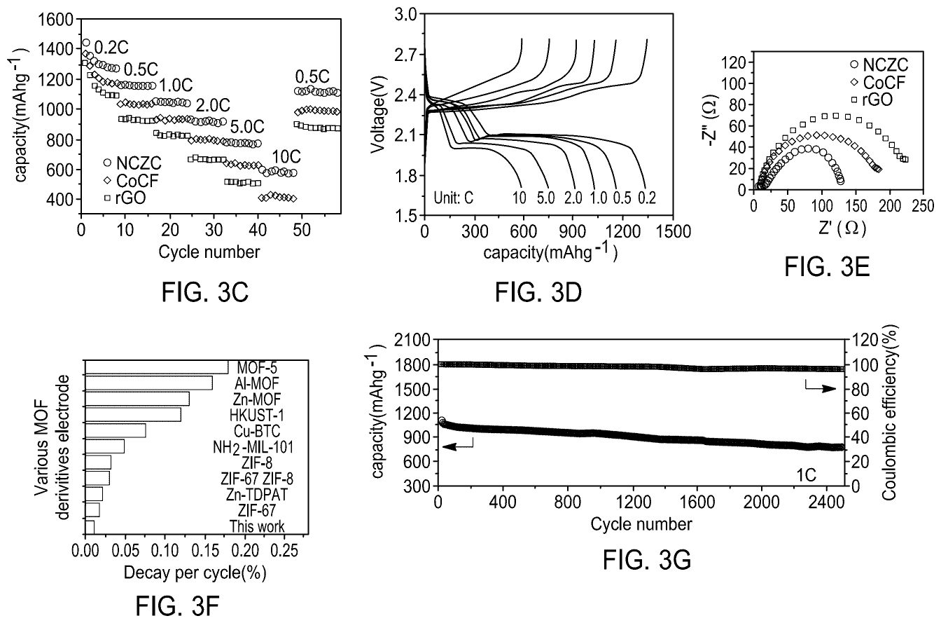

Encouraged by the highly networked structure, NCZC was tested as a sulfur host for Li—S batteries and compared with cells based on rGO aerogel or CoCF. All these batteries exhibit typical two-discharge plateau curves (see FIG. 3A) consistent with the formation of high-order and low-order LiPS. Notably, the NCZC enables the lowest potential gap between the discharge and charge curves among these various cells, and simultaneously enables much sharper peaks and smaller electrochemical polarization in the cyclic voltammetry (CV), suggesting facile redox kinetics in the NCZC electrode. The galvanostatic cycling performances of the cells with different electrodes (see FIG. 3B) shows that NCZC cells delivers a high initial capacity of 1351 mAhg⁻¹, exceeding of the state-of-the-art rGO based sulfur host (1192 mAhg⁻¹). It also exceeds the capacity of CoCF-based cells (1296 mAhg⁻¹), implying greatly improved sulfur utilization due to the hierarchical multiscale design. A high-capacity retention of 1205 mAhg⁻¹ and a Coulombic Efficiency (CE) close to 99% for the sequence of over 100 cycles were also achieved for NCZC cathodes indicating its operational durability over those of the other sulfur host designs (970 mAhg⁻¹, CE: 97% for CoCF electrode; 832 mAhg⁻¹, CE: 92% for rGO electrode). Impressively, the shape of charge/discharge curves is virtually unchanged from the 1st to the 100th cycle for NCZC-based cell (see FIG. 6) which suggests that the multiscale design effectively limits the diffusion of LiPS and stabilizes sulfur redox reactions. The functional advantage in higher initial discharge capacity, lower potential gap, and long operational durability of the NCZC is believed to be ascribed to its structure-being a highly porous, conductive network of the carbonized ANFs complemented by the CNTs. The morphology of NCZC electrode is further characterized to evaluate the structural stability of NCZC upon the cycling process. The hierarchical nanofiber-based architecture is retained from disassembled after 100 cycles, suggesting the remarkable structural stability of NCZC during the battery cycling process.

Various-rate and long-term cycling tests were further conducted to investigate its rate capability and cyclability (see FIGS. 3C-3G). Even at a high current density up to 10C, the NCZC cell still delivers a highly reversible capacity of close to about 600 mAhg⁻¹ and quickly recovers to about 1040 mAhg⁻¹ when the current density switches back to 0.5C, indicating the fast charge transport and fast charge transport to sulfur. Despite the voltage plateaus on discharge curve drops at the high current density, the sloping shape remains almost unchanged (see FIG. 3D), further confirms the rapid sulfur redox conversion from the NCZC-based cell. This conclusion also can be further evidenced by the Nyquist plots (see FIG. 3E), where the semicircle in the high-frequency region is much smaller for NCZC than for rGO and CoCF electrodes due to the lower charge transfer resistance. Conversely, the rGO- and CoCF-based cells display much inferior capacity of about 302 mAhg⁻¹ and about 420 mAhg⁻¹ at the high current density of 10C (see FIG. 3C). Equally importantly, NCZC cells also shows a superb cycling life exceeding 2500 cycles with a negligible capacity decay of 0.011% per cycle and a Coulombic Efficiency (CE) consistently above 98% at a current rate of 1.0C (see FIG. 3G). It is noteworthy that the rate capability, cycle life and capacity retention of the NCZC corresponding batteries are superior to those of the previously reported representative MOF-derived or carbon-based sulfur hosts electrodes (see FIG. 3F and in Tables 1 and 2), strongly supporting the advantages of NCZC as an advanced sulfur host in a cathode for Li—S batteries.

TABLE 1
The comparison of rate capability and long-term cyclability of HFN electrode
with representative sulfur electrode based on MOFs-derived carbon host.

| | | | | Long-term Cyclability | | | |
|---|---|---|---|---|---|---|---|
| | | Rate Capability | | Rate | Capacity | | |
| | MOF | Highest | Capacity | (IC = 1675 | fade(% | Number | |
| Sample | source | Rate | (mAhg⁻³) | mA g⁻³) | per cycle) | of cycle | REF |
| This work | ZIF-67 | 10 C | 602 | 1 C | 0.011% | 2500 | |
| N—Co₃O₄@N—C/rGO | ZIF-67 | 3 C | 652 | 2 C | 0.034% | 1000 | (10) |
| Co—NGC | ZIF-67 | 5 C | 565 | 1 C | 0.09% | 500 | (11) |
| L₃_{₂}S@C—Co—N | ZIF-67 | 4 C | 604.1 | 0.2 C | 0.06% | 300 | (12) |
| NPC/G | ZIF-67 | 1 C | 786 | 1 C | 0.043% | 300 | (13) |
| CPZC | ZIF-67 | 10 C | 622.6 | 1 C | 0.016% | 2000 | (14) |
| GC | ZIF-67 | 2 C | 287 | 0.5 C | 0.055% | 500 | (15) |
| RGO/C—Co—S | ZIF-67 | 2Ag⁻¹ | 606 | 0.2 | — | 300 | (16) |
| HPTCF | ZIF-67 | 5 C | 483.8 | 1 C | 0.018% | 600 | (17) |
| CNT-GC@NC | ZIF-67 | 2 C | 280 | 1 C | 0.032% | 800 | (18) |
| | ZIF-8 | | | | | | |
| ZIF-8-NS-C | ZIF-8 | 2 C | 785 | 0.5 C | 0.12% | 300 | (19) |
| BHPC-950 | ZIF-8 | 2 C | 967 | 0.5 C | 0.054% | 1000 | (20) |
| NDC | ZIF-8 | — | — | 0.2 C | 0.17% | 100 | (21) |
| P@rGO/ZIF-8(C) | ZIF-8 | 2 C | 688 | 1 C | 0.03% | 500 | (22) |
| CNTs@ZIF-8 | ZIF-8 | 1 C | 550 | 1 C | 0.05% | 300 | (23) |
| N-ZDC | ZIF-8 | 2 C | 758 | 2 C | 0.048% | 800 | (24) |
| HPCN | MOF-5 | — | — | 0.5 C | — | 50 | (25) |
| GO@Meso-C | MOF-5 | 2 C | 550 | 0.2 C | 0.27% | 100 | (26) |
| AMCP-950/S | MOF-5 | 2 C | 441 | 0.2 C | 0.37% | 50 | (27) |
| Ti₃C₂Tₓ@Meso-C/S | MOF-5 | 4 C | 544.3 | 0.5 C | 0.18% | 300 | (28) |
| ISCF | HKUST-1 | 10 C | 650 | 1 C | 0.0054% | 500 | (29) |
| C@Cu_{1.26}S | HKUST-1 | 2 C | 134 | 0.1 C | 0.12% | 50 | (30) |
| CN-5@NSHPC | NH₂-MIL- | 5 C | 387 | 1 C | 0.048% | 500 | (31) |
| | 101(A1) | | | | | | |
| CHPCF | Cu-BTC | 15 C | 535 | 5 C | 0.076% | 500 | (32) |
| FMNCN | Zn-TDPAT | 5 C | 759 | 2 C | 0.02% | 1000 | (33) |
| FLHPC | Al-MOF | 2 C | 763 | 0.5 C | 0.16% | 200 | (34) |
| MPCN | Zn-MOF | 2 C | 850 | 0.5 C | 0.13% | 200 | (35) |

BHPC: bicontinuous hierarchical porous carbon; CPZC: tube on cube carbonaceous hybrid; HPTCF: hollow carbon polyhedra embedded on tubular carbon fabric; NDC: nitrogen-doped carbon; N-ZDC: N-doped ZIF-8-derived carbon nanosphere; HPCN: porous carbon nanoplates; AMCP: activated mesoporous carbon polyhedron; ISCF: self-standing conductive framework; NSHPC: N, S co-doped hollow porous carbon shell; CHPCF: cross-linking hierarchical porous carbon fibers; FMNCN: flowerlike microporous nitrogen-doped carbon nanosheets; FLHPC: fries-like hierarchical porous carbon; MPCN: micro/meso porous carbon nanorod; rGO: reduced graphene oxide; GO: graphene oxide; CNT: carbon nanotube; NS: nanosheets; MWCNT: multi-walled carbon nanotubes; Meso: mesoporous; GC: graphitic carbon; PC: porous carbon.

TABLE 2
Electrochemical performance comparison of various carbon-based cathodes in Li—S batteries

| | Mass loadling | | | | |
|---|---|---|---|---|---|
| Sample | of Sulfur (mg | Rate (1 C = | | Discharge capacity (mAhg⁻¹); Cycle | |
| (Cathode) | cm⁻²) | 1675 mAg⁻¹) | | number; Decay per cycle | REF |
| This work | 3.84 | 1 | C | 1048 (2500 cycles, 0.011% per | |
| | | | | cycle) | |
| Carbon nanofibers | 2.0-3.0 | 1 | C | 745 (1500 cycles, 0.043% per cycle) | (36) |
| Carbon fiber | 6.5 | 150 | mA g⁻¹ | 1057 (80 cycles, 0.30% per cycle) | (37) |
| Microporous carbon | 0.8 | 50 | mA g⁻¹ | 900 (100 cycles, 0.29% per cycle) | (38) |
| nanofibers-CNT | | | | | |
| composite | | | | | |
| GO | 2.0 | 1 | C | 727 (500 cycles, 0.008% per cycle) | (39) |
| Graphene | 2.0 | 2 | C | 966 (500 cycles, 0.099% per cycle) | (40) |
| Graphene aerogel | 2.0 | 0.5 | C | 657 (300 cycles, 0.129% per cycle) | (41) |
| Graphene foam | 10.1 | 1.5 | Ag⁻¹ | 1000 (1000 cycles, 0.071% per cycle) | (42) |
| Crumpled N-doped | 5.0 | 0.155 | C | 1000 (100 cycles, 0.12% per cycle) | (43) |
| graphene | | | | | |
| N-graphene | 5.2 | 0.192 | C | 990 (80 cycles, 0.75% per cycle) | (44) |
| g-C₃N₄ composite | | | | | |
| 3D graphene foam/rGO | 9.8 | 0.2 | C | 1000 (350 cycles, 0.1% per cycle) | (45) |
| Graphene encapsulated in | 5.0 | 1.0 | C | 899.9 (500 cycles, 0.04% per cycle) | (46) |
| hollow mesoporous | | | | | |
| carbon nanosheet | | | | | |
| N/S-co-doped graphene | 4.6 | 2 | C | 430 (500 cycles, 0.078% per cycle) | (47) |
| sponge | | | | | |
| rGO wrapped N,P- | 4.1 | 0.5 | C | 1024 (100 cycles, 0.046% per cycle) | (48) |
| codoped mesoporous | | | | | |
| carbon | | | | | |
| PEDOT/PSS-graphene | 3.0 | 1 | C | 1008 (500 cycles, 0.04% per cycle) | (49) |
| composite | | | | | |
| CNT | 2.0-3.0 | 6 | A g⁻¹ | 712 (100 cycles) | (50) |
| Mesoporous CNT | 1.875 | 0.1 | C | 1109 (100 cycles, 0.314% per cycle) | (51) |
| N-doped porous carbon- | 1.5 | 1 | C | 986 (600 cycles, 0.105% per cycle) | (32) |
| CNT | | | | | |
| 3D CNT foam | 19.1 | 0.1 | C | 1010 (1000 cycles, 0.53% per cycle) | (53) |
| Porous carbon | 2.36 | 2 | C | 1115 (1000 cycles, 0.039% per cycle) | (54) |
| Microporous carbon | 1.0 | 0.5 | C | 378 (200 cycles, 0.1% per cycle) | (55) |
| Popcorn inspired porous | 4.0 | 0.2 | C | 1257.2 (500 cycles, 0.087% per | (56) |
| macrocellular carbon | | | | cycle) | |
| N/O co-doped carbon | 2.37 | 800 | mAg⁻¹ | 690 (180 cycles, 0.046% per cycle) | (57) |
| N/P co-doped porous | 1.0-1.8 | 1 | C | 810 (200 cycles, 0.145% per cycle) | (58) |
| carbon | | | | | |
| N-doped carbon | 5.0 | 0.1 | C | 1480 (200 cycles, 0.05% per cycle) | (59) |
| composites | | | | | |
| N-doped hollow carbon | 3.9 | 0.2 | C | 1360 (100 cycles, 0.30% per cycle) | (60) |
| spheres | | | | | |
| N-doped hollow porous | 1.1-1.5 | 1 | C | 894 (400 cycles, 0.053% per cycle) | (61) |
| carbon bowls | | | | | |
| Carbon polyhedrons | 6.4 | 0.2 | C | 890 (300 cycles, 0.07% per cycle) | (62) |
| Polyaniline | 2.0 | 0.2 | C | 1100 (200 cycles, 0.15% per cycle) | (63) |

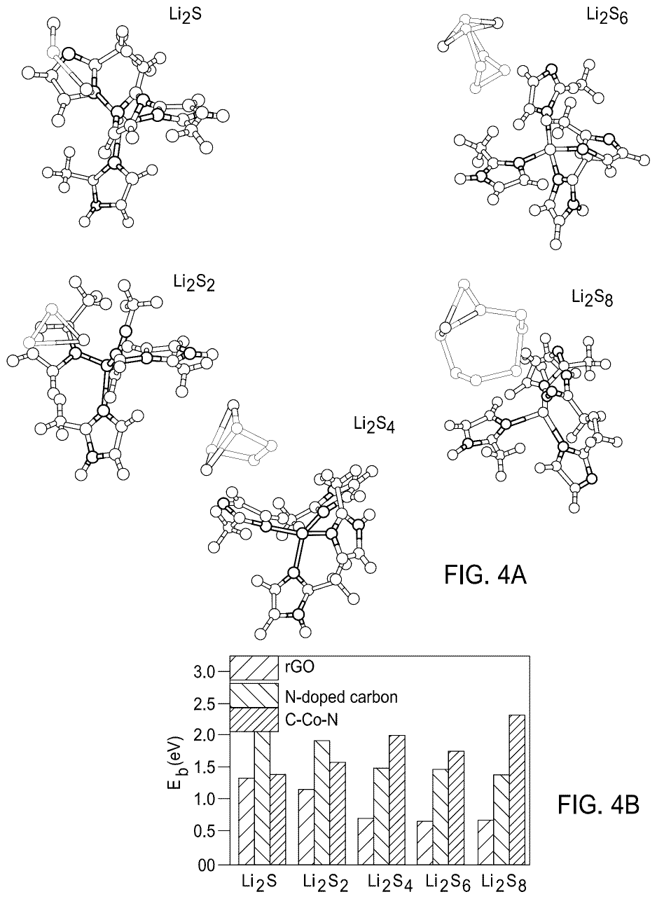

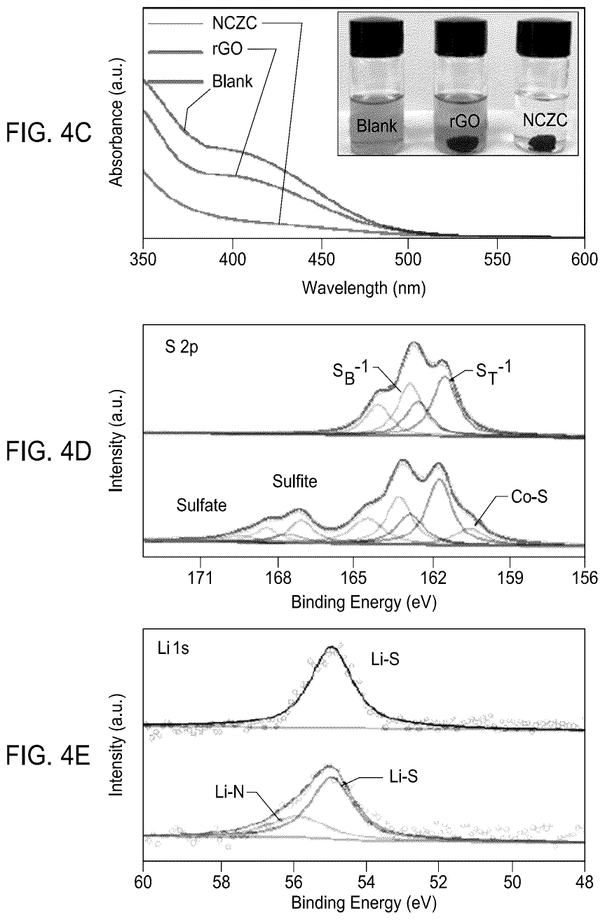

To quantitatively describe the LiPS chemisorption by NCZC was evaluated by the density functional theory (DFT) calculations (see FIGS. 4A and 4B). In contrast to weak binding of high-order LiPS, such as Li₂S₈, Li₂S₆ and Li₂S₄, to rGO, their binding to NCZC is much stronger (see FIGS. 4A and 4B and Table 3), which makes possible chemical entrapment of LiPS preventing their transport to Li anode.

TABLE 3
Table showing the calculated binding energy of Li—S species with
C—Co—N, N-doped carbon from HFN and rGO, respectively.

| | Li₂S₈ | Li₂S₆ | Li₂S₄ | Li₂S₂ | Li₂S |
|---|---|---|---|---|---|
| C—Co—N | 2.29 eV | 1.73 eV | 1.95 eV | 1.54 eV | 1.38 eV |
| Pyridinic N | 1.34 eV | 1.46 eV | 1.45 eV | 1.93 eV | 2.02 eV |
| rGO | 0.67 eV | 0.66 eV | 0.69 eV | 1.13 eV | 1.29 eV |

For low-order LiPS, such as Li₂S₂ and Li₂S, the binding energy is even higher, which is important to prevent LiPS cross-over and advantages over rGO. The theoretical prediction of LiPS affinity of NCZC was experimentally confirmed taking advantage of colorimetry of LiPS. After about 24 hours of rGO and NCZC being dispersed into the Li₂S₄ solution, the NCZC test exhibits a much lighter color than that for rGO (see FIG. 4C), consistent with much weaker peaks at 415 nm from S₄²⁻ observed in UV-vis spectra (see FIG. 4C). The chemical polysulfide adsorption is further evaluated by XPS analysis (see FIG. 4D). Specifically, two pairs typical binding energies located at about 161.5 eV and about 162.8 eV are observed in the S₂p spectrum of Li₂S₄, which are attribute to the terminal (S_{T}⁻¹) and bridging sulfur (SB⁰), respectively. After being contacted by NCZC, a slight shift of these peaks towards a higher binding energy range is perceived, which illustrates the reduction of the electron cloud density in the sulfur atoms due to the formation of the chemical interaction between Li₂S₄ and NCZC. Meanwhile, two new pairs of peaks emerge in the high binding energy range, which corresponds to sulfite and sulfate, representing the interaction between polysulfide and oxidic species in NCZC. Another one new peak emerges at 160.5 eV originated from Co—S bonding, suggesting the interaction between polysulfide and the Co sites. Moreover, the Li₁ₛ spectra shows a broadened peak after absorbed by NCZC and witnesses a new subpeak appearing at 55.7 eV originated from the formation of Li—N bonding (see FIG. 4E), which is consistent with the above XPS analysis. These variations in XPS spectra collectively demonstrate the strong chemical adsorption ability of NCZC to LiPS, which chemically enhance the electroactive material confinement in Li—S batteries.

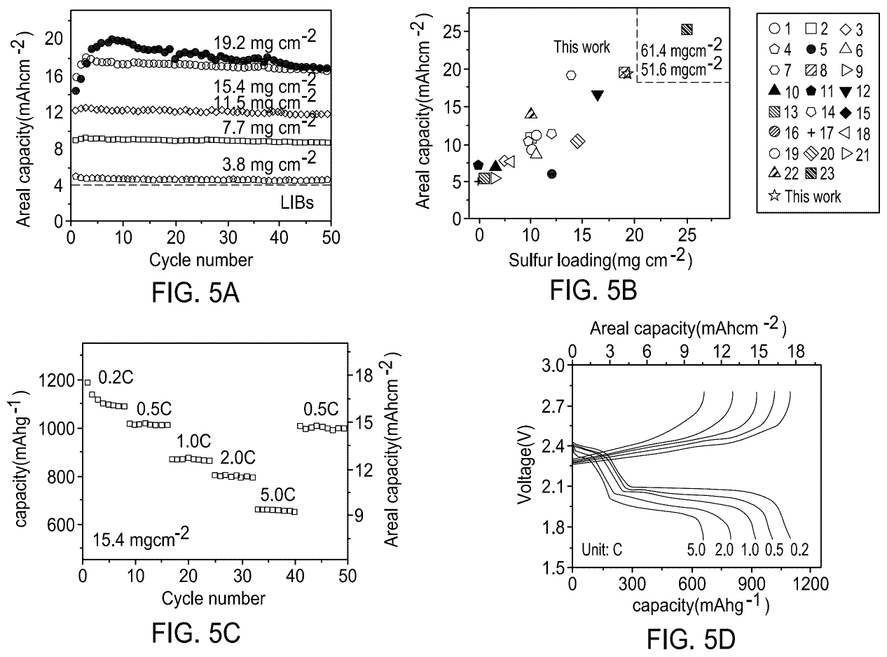

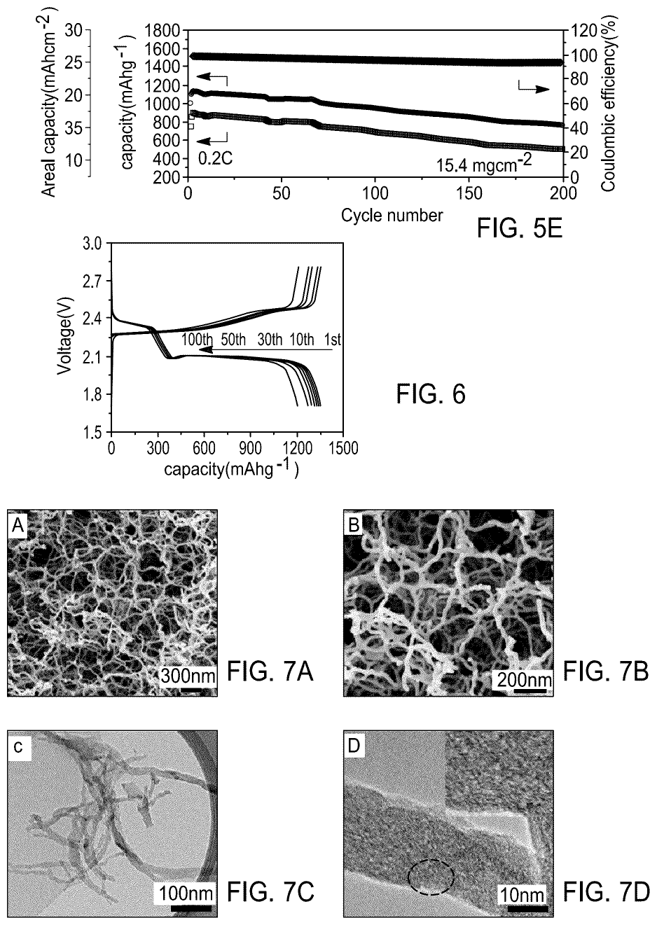

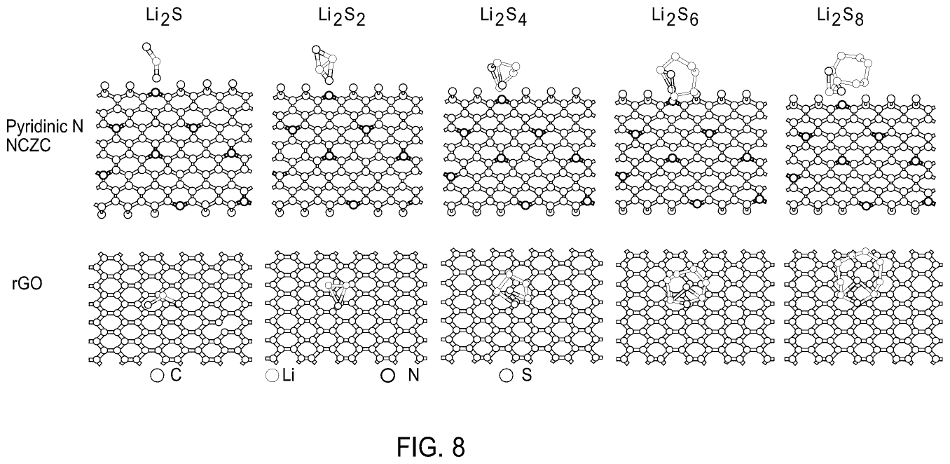

To achieve a cathode material more compatible with high-energy-density and scale-up commercial battery manufacturing process, the sulfur host of NCZC with higher areal sulfur loadings of 7.68, 11.52, 15.36, and 19.20 mg cm⁻² with a control E/S ratio of 8:1 were also prepared. The cell with the sulfur loading of 15.36 mg cm⁻² still presents a high reversible areal capacity up to 17.0 mAh cm⁻² over 50 charge/discharge cycles (see FIG. 5A), which outperforms most of state-of-the-art sulfur hosts specifically designed for high-sulfur-loading (see FIG. 5B and Table 4) as well as the commercial lithium-ion batteries.

TABLE 4
Comparison of areal capacity of the HFN with that of recent publications in
Li—S batteries that have high sulfur loadings more than 5 mg cm⁻².

| | | Mass loading | Rate (mA cm⁻²) | Areal capacity | |
|---|---|---|---|---|---|
| Number | Sample | (mg cm⁻²) | (1 C = 1675 mAg⁻¹) | (mAh cm⁻²) | REF |
| | This work | 15.4 | 0.2 C | 17.0 (Initial) | |
| | | | | 10.1(200 cycles) | |
| | | 19.2 | 0.2 C | 19.5 (Initial) | |
| | | | | 15.5(50 cycles) | |
| 1 | Graphene foam | 10.1 | 3.6 | 9.3(Initial) | (42) |
| 2 | N-graphene g-C₃N₄ | 10.2 | 1.0 | 10.8 (Initial) | (44) |
| | | | | 6.0 (50 cycles) | |
| 3 | Crumpled N- doped | 5.0 | 1.3 | 5.0 (Initial) | (43) |
| | graphene | | | 4.2 (100 cycles) | |
| 4 | 3D graphene | 12.0 | 0.1 C | 6.0 (Initial) | (64) |
| | | | | 4.2 (300 cycles) | |
| 5 | 3D graphene foam/rGO | 9.8 | 0.2 C | 10.3 (Initial) | (45) |
| | | | | 6.1 (350) | |
| 6 | Poly sulfur-graphene | 10.5 | 3.52 | 8.7 (Initial) | (65) |
| | | | | 6.7 (100 cycles) | |
| 7 | N/S-co-doped | 8.5 | 7.1 | 7.9 (Initial) | (47) |
| | graphene sponge | | | 5.7 (200 cycles) | |
| 8 | 3D CNT foam | 19.1 | 0.32 | 19.3 (Initial) | (53) |
| | | | | 9.0 (100 cycles) | |
| 9 | Carbon polyhedrons | 6.4 | 0.2 C | 5.5 (Initial) | (62) |
| | | | | 4.1 (300 cycles) | |
| 10 | Carbon fiber | 6.5 | 0.1 C | 6.87 (Initial) | (37) |
| | | | | 5.2 (100 cycles) | |
| 11 | N-doped carbon | 5.0 | 0.84 | 7.2 (Initial) | (59) |
| | composites | | | 6.0 (100 cycles) | |
| 12 | Hollow carbon fiber foam | 16.5 | 0.1 C | 16.5 (Initial) | (66) |
| | | | | 12.0 (50 cycles) | |
| 13 | Thick carbon layer | 13.9 | 2.33 | 19.2 (Initial) | (67) |
| | | | | 10.3 (300 cycles) | |
| 14 | TiS₂-Polysulfide | 12 | 2.01 | 11.5 (Initial) | (68) |
| | | | | 9.0 (50 cycles) | |
| 15 | VS₂-graphene | 5.0 | 1.68 | 5.1 (Initial) | (69) |
| | | | | 4.0 (50 cycles) | |
| 16 | Vanadium Nitride | 5.4 | 4.52 | 5.43 (Initial) | (70) |
| | | | | 4.3 (200 cycles) | |
| 17 | Co@N—C composite | 7.5 | 0.63 | 7.75(Initial) | (71) |
| 18 | CNT/nanofibrillated | 8.1 | 3.4 | 7.69 (Initial) | (72) |
| | cellulose | | | 6.8 (50 cycles) | |
| 19 | Co9S8-3D graphene foam | 10.4 | 0.1 C | 10.9 (Initial) | (73) |
| | | | | 7.5 (200 cycles) | |
| 20 | MgO-Decorated Carbon | 14.4 | 0.1 C | 10.4 (Initial) | (74) |
| | Foam@CNTs | | | 8.8 (60 cycles) | |
| 21 | Graphene encapsulated in | 10.0 | 0.1 C | 13.9 (Initial) | (46) |
| | hollow mesoporous | | | 11.4 (50 cycles) | |
| | carbon nanosheet | | | | |
| 22 | Porous carbon nanofibers | 12.1 | 0.2 C | 11.3 (Initial) | (75) |
| 23 | Carbon-cotton | 61.4 | 0.1 C | 56.5 (Initial) | (76) |

Further increase of sulfur loading to 19.2 mg cm⁻² results in limited capacity improvement due to the hindered electron/ion transfer. At a high current density of 5C, the NCZC cells with sulfur content as high as about 15.36 mg cm⁻² achieve a highly reversible capacity of about 9.9 mAhcm⁻² (642.8 mAhg⁻¹) (see FIGS. 5C and 5D). When the charge-discharge rate is switched back to 0.5C, a quick rise of capacity to about 15.8 mAhcm⁻² (1023.3 mAhg⁻¹) is observed. Cycling performance tests in FIG. 5E show that the NCZC electrode has a high reversible areal capacity of about 10.2 mAhcm⁻² (662.3 mAhg⁻¹) at 0.2 C with a low-capacity decay rate of 0.20% over 200 cycles, also indicating a marked increase of cycling stability and capacity retention compared to other sulfur hosts.

In certain variations, a highly efficient sulfur hybrid host material with a hierarchical architecture that includes a carbon fibrous aerogel skeleton, Co-embedded, N-doped porous carbon paired with abundant growth N-doped carbon nanotubes. Benefiting from the improved conductivity by N-doped carbon substrate, suppressed shuttle phenomenon by strong binding affinity between polysulfide and polar active sites, facilitated sulfur redox kinetics by sufficient electrode/electrolyte interfaces, and greater tolerance of volume changes with porous structures, the as-constructed sulfur host material manifests an exceptional rate capability up to 10C, remarkable cycle durability over 2500 cycles with an ultra-low-capacity decay of 0.011% per cycle and high reversible specific/areal capacity of 17.0 mAhcm⁻² at a high sulfur loading of 15.36 mg cm⁻² with sparing electrolyte, which demonstrates its great potential in Li—S batteries.

In summary, the present disclosure provides a new porous network for cathodes of high-performance Li—S batteries by addressing many of the inherent issues faced by conventional sulfur host materials. The well-defined 3D hierarchical hybrid architecture creates a hierarchically scaled conductive network with facile electron/ion transfer, while the highly porous structure with abundant active Co and N sites exposes interfaces for LiPS entrapment and facile sulfur redox kinetics. Furthermore, the growth N-CNTs on the porous carbon not only offers additional polar sites of nitrogen (N) for chemical anchoring of lithium polysulfides (LiPS), also interlinking the adjacent 3D nanofibers framework to intensify the structural integrity and provide high-rate charge transfer within the entire electrode. Attributed to these unique and synergistic superiorities, the as-constructed NCZC prepared in accordance with certain aspects of the present disclosure provides a sulfur host material for a cathode having fast reaction kinetics, high sulfur utilization, superior rate performance and ultralong cycle life with a very low-capacity decay at both low and high sulfur loadings with sparing electrolyte. The present disclosure provide new methods for designing cathode structures and chemical interaction of active materials toward realization of the high-energy density and long-life Li—S batteries for practical applications, as well as in other energy storage such as supercapacitors, metal-ion or metal-air batteries and the like.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

What is claimed is:

1. An electrode material comprising:
a sulfur electroactive material; and
a sulfur host material configured to receive the sulfur electroactive material, the sulfur host material comprising:
a fibrous carbonaceous network;
an electroactive metal associated with the fibrous carbonaceous network; and
a plurality of carbon nanotubes formed on the fibrous carbonous network.

2. The electrode material of claim 1, wherein the electroactive metal comprises a transition metal.

3. The electrode material of claim 2, wherein the transition metal comprises cobalt.

4. The electrode material of claim 1, wherein the electroactive material is adsorbed on a surface of the fibrous carbonaceous network.

5. The electrode material of claim 1, wherein the electroactive material is embedded in the fibrous carbonaceous network.

6. The electrode material of claim 1, wherein the electroactive material is adsorbed on a surface of the fibrous carbonaceous network and embedded in the fibrous carbonaceous network.

7. The electrode material of claim 1, wherein the plurality of carbon nanotubes are formed on the fibrous carbonous network at sites of the electroactive metal.

8. The electrode material of claim 1, wherein the plurality of carbon nanotubes are nitrogen-doped.

9. The electrode material of claim 1, wherein the electrode material has an areal capacity of greater than or equal to about 17 mAhcm⁻².

10. The electrode material of claim 1, wherein the electrode material has a sulfur loading of greater than or equal to about 15 mg/cm².

11. A lithium-sulfur electrochemical cell comprising:
a positive electrode comprising:
a sulfur electroactive material; and
a sulfur host material configured to receive the sulfur electroactive material, the sulfur host material comprising:
a fibrous carbonaceous network,
an electroactive metal associated with the fibrous carbonaceous network, and
a plurality of carbon nanotubes formed on the fibrous carbonous network;
a negative electrode comprising lithium;
a separator disposed between the positive electrode and the negative electrode; and
an electrolyte incorporated into at least one of the positive electrode, the negative electrode, and the separator.

12. The lithium-sulfur electrochemical cell of claim 11, wherein the electroactive metal comprises a transition metal.

13. The lithium-sulfur electrochemical cell of claim 11, wherein the electroactive material is adsorbed on a surface of the fibrous carbonaceous network, the electroactive material is embedded in the fibrous carbonaceous network, or the electroactive material is adsorbed on a surface of the fibrous carbonaceous network and embedded in the fibrous carbonaceous network.

14. The lithium-sulfur electrochemical cell of claim 11, wherein the plurality of carbon nanotubes are formed on the fibrous carbonous network at sites of the electroactive metal.

15. The lithium-sulfur electrochemical cell of claim 11, wherein the plurality of carbon nanotubes are nitrogen-doped.

16. The lithium-sulfur electrochemical cell of claim 11, wherein the positive electrode has an areal capacity of greater than or equal to about 17 mAhcm⁻² and a sulfur loading of greater than or equal to about 15 mg/cm².

17. The lithium-sulfur electrochemical cell of claim 11, wherein the lithium-sulfur electrochemical cell has an electrolyte-to-sulfur ratio (E/S) ratio of less than or equal to about 8:1.

18. A method of making an electrode for a lithium-sulfur electrochemical cell, the method comprising:
pyrolyzing a porous membrane formed from a plurality of aramid nanofibers and comprising a plurality of metal organic framework nanoparticles to form a fibrous carbonaceous network;
incorporating a transition metal into the fibrous carbonaceous network; and
forming a plurality of carbon nanotubes on a plurality of sites associated with the transition metal in the fibrous carbonaceous network to form a sulfur host material configured to receive a lithium-sulfur electroactive material that cycles lithium ions.

19. The method of claim 18, wherein the method further comprises:
forming the porous membrane by spin coating the plurality of aramid nanofibers and incorporating the plurality of metal organic framework nanoparticles therein.

20. The method of claim 18, wherein the metal organic framework nanoparticles comprise a plurality of zeolitic imidazolate framework-67 (ZIF-67) particles and the transition metal comprises cobalt.
